(19) United States
(12) Patent Application Publication
(10) Pub. No.: US 2005/0039389 A1
(43) Pub. Date: Feb. 24, 2005

(54) Plant saver

(76) Inventor: Karine Ann-Marie Partikian, St.-Lazare (CA)

Correspondence Address: Karine Partikian, 2295 Nest, St.-Lazare, QC, J712G7, CA

(21) Appl. No.: 10/642,571

(22) Filed: Aug. 18, 2003

(51) Int. Cl. A01G 13/00

(52) U.S. Cl. 47/30

(57) ABSTRACT

The present invention is a revolutionary new concept which serves as a cover/entrapment system for all plant/flower pots. It discourages household animals and children from disturbing the earth contents, of the plant. The cover system allows the use of any fabric material, which permits watering, and fertilizing of the plant without removal of the cover. The chosen material, transparent, colored or patterned will cover the soil and cover the rim of the pot. This cylindrical fabric sleeve slips under the pot and is fitted around the rim by an elastic band. The remaining part of the sleeve is then pulled up and over the pots rim and soil to be adjusted with a drawstring and fastener to the base of plant or flowered stem.

1. This invention relates to a device used specifically to prevent household pets and children from playing or defecating in plant soil. I

2. This device is to counter the use of chemical and potentially hazardous materials sold in pet stores, to deter household pet to use potted plants as a toilet, and prevents children from playing in soil, and saves parent from potential mess and poisoning.

3. I have found that the advantage of using the plant saver has eliminated many messy situations from my cat, which is no longer attracted to digging/defecating in my potted plants.

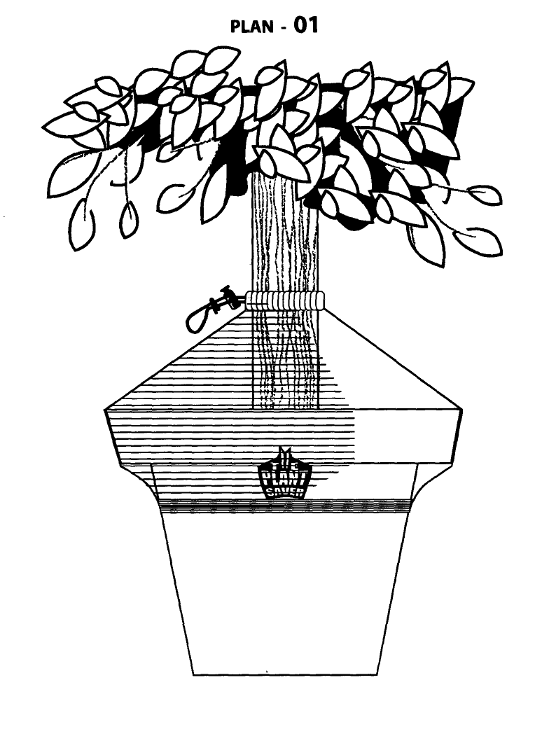

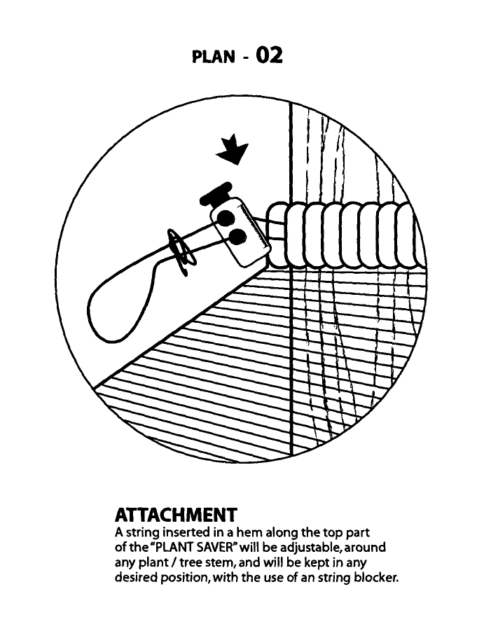

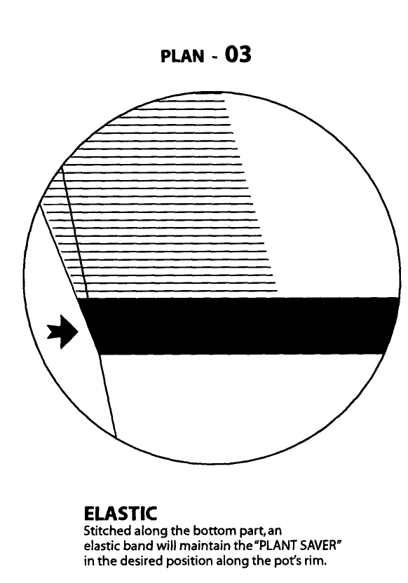

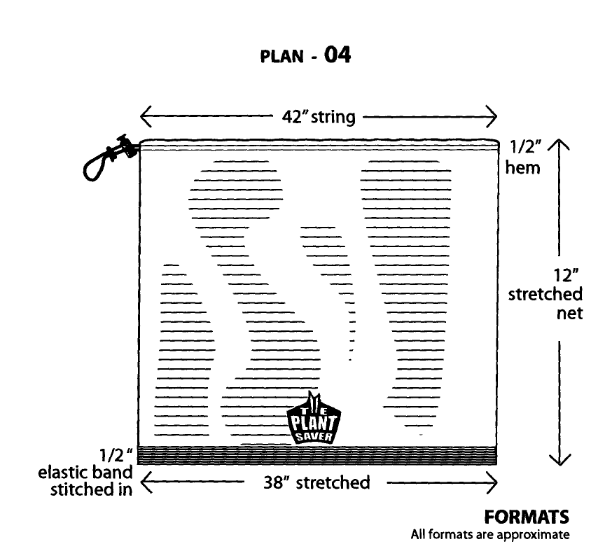

4. The revolutionary plant saver is easy to install, and it does not require the use of any tools for its installation, it is also machine washable. The plant saver is environmentally friendly and does not harm the ozone layer as do previously used chemical deterrents. In the drawings that illustrate the plant saver FIG. 1 depicts the final concept of the plant saver, FIG. 2 is the attachment consisting of drawstring and fastener adjustable to size. FIG. 3 shows the bottom elastic band which keeps the plant saver in the desired position along the pots rim.

1. The plant saver serves as a cover/entrapment for all plant/flower pots. It discourages household animals and children from disturbing the earth contents, of the plant. The cover system allows the use of any fabric material, which also permits watering without removal of the plant saver cover. The plant saver also allows for normal plant growth from its adjustable drawstring feature. The chosen material;transparent, colored or patterned will cover the soil and below the rim of the pot.

2. A multifunctional plant saver covering according to claim.

3. The plant saver is a rectangular piece of any material, in varios dimensions to fit planters. The side of which is sewn together into a cylindrical shape. The top has a sleeve to accommadate the drawstring with fastener. The bottom of the cylinder has a fitted elastic to hug the pot tightly and/or permitting various sized pots.

4. A multifunctional plant saver covering according to claim.
